(19) United States
(12) Patent Application Publication
(10) Pub. No.: US 2014/0262650 A1
(43) Pub. Date: Sep. 18, 2014

(54) ROTARY SHOCK ABSORPTION TOOL

(71) Applicant: SMITH INTERNATIONAL, INC., Houston, TX (US)

(72) Inventor: Jay M. Eppink, Spring, TX (US)

(73) Assignee: SMITH INTERNATIONAL, INC., Houston, TX (US)

(21) Appl. No.: 14/198,381

(22) Filed: Mar. 5, 2014

Related U.S. Application Data
(60) Provisional application No. 61/782,313, filed on Mar. 14, 2013.

(51) Int. Cl. F16F 13/00; F16F 9/26

(52) U.S. Cl. CPC F16F 13/007; F16F 9/26
USPC 188/297

(57) ABSTRACT

Apparatuses, tools, assemblies, and methods are disclosed for reducing vibration. A shock absorption apparatus may include a stator and a rotor inside the stator. A first piston section may be included and define a first piston chamber having a first piston therein. The first piston chamber may be fluidly coupled to a first end portion of an annulus defined in a region between the stator and the rotor. A second piston section may also be defined and may include a second piston chamber with a second piston therein. The second piston chamber may be fluidly coupled to a second end portion of the annulus.

### CROSS-REFERENCE. TO RELATED APPLICATIONS

This application claims the benefit of, and priority to, U.S. Patent Application Ser. No. 61/782,313, filed on Mar. 14, 2013 and entitled “ROTARY SHOCK TOOL,” which application is incorporated herein by this reference in its entirety.

### BACKGROUND

In the drilling, completing, or reworking of oil wells, a variety of downhole tools may be used. For instance, a drilling tool assembly may include a drill string coupled to a bottomhole assembly including a drill bit. The drill string may include several joints of drill pipe connected end-to-end through one or more tool joints, and the drill string may transmit drilling fluid (such as through a central bore) and/or rotational torque from a drill rig to the drill bit. If so equipped, the bottomhole assembly may use a downhole motor (e.g., mud motor) to transmit torque to the drill bit.

Fluid may be conveyed downhole through a hydraulic passage provided by the drill pipe. The fluid (e.g., mud) may be pumped from the surface and may exit the drilling tool assembly at multiple orifices in the drill bit (e.g., jets). These orifices may be used to discharge the drilling fluid for the purposes of cooling the drill hit and carrying rock or other cuttings out of wellbore during drilling.

A combination of one or more of axial, lateral, or rotational vibration (e.g., movement, oscillations, etc.) may be imparted to the drill bit and drill string (including the bottomhole assembly) from various downhole and/or surface forces. Vibration may cause the drilling apparatus, including drill string, bottomhole assembly, and drill bit, to bend, twist, bounce, or otherwise deviate off-course. In some cases, the formed wellbore may be larger than desired, may have an off-course trajectory, or may have poor wellbore quality. Further, vibration may cause damage to one or more of the drill string components and/or any other downhole components.

### SUMMARY

In one aspect, embodiments disclosed herein relate to a shock absorption apparatus that includes a stator and a rotor inside the stator. An annulus may be defined in a region between the stator and the rotor. A first piston section may define a first piston chamber fluidly coupled to a first end portion of the annulus, and a second piston section may define a second piston chamber fluidly coupled to a second end portion of the annulus. Each of the first and second piston chambers may have a piston therein.

In another aspect, embodiments disclosed herein relate to a tool having, a helical stator and an eccentric helical rotor disposed within the helical stator, such that an annulus is defined between the helical stator and the eccentric helical rotor. The tool may also include a first piston chamber haying a first piston therein, which first piston may separate the first piston chamber into respective first and second sides. The first side of the first piston chamber may be in fluid communication with the annulus, and the second side of the first piston chamber may have a dampening member therein. The tool may also include a second piston chamber having a second piston therein, which second piston may separate the second piston chamber into respective first and second sides. The first side of the second piston chamber may be in fluid communication with the annulus, and the second side of the second piston chamber may have a dampening member therein.

In another aspect, embodiments disclosed herein may relate to a method that includes rotating, a bit coupled to a rotor. The rotor may be inside a stator, and rotating the bit may cause the rotor to rotate with respect to the stator. Fluid may flow through an annulus formed between the rotor and the stator, and to a first piston chamber. Such flow may occur in response to rotation of the rotor with respect to the stator. Energy from the fluid may be dampened using a first dampening member within the first piston chamber.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF DRAWINGS

FIG. 1 is a schematic view of a drilling rig according to some embodiments of the present disclosure.

FIG. 2 shows a cross-sectional view of a shock apparatus in accordance with one or more embodiments of the present disclosure.

FIG. 3 shows an enlarged cross-sectional view of an upper housing, section coupled to an upper portion of a first piston section of a shock apparatus in accordance with one or more embodiments of the present disclosure.

FIG. 4 shows an enlarged cross-sectional view of a lower portion of a first piston section coupled to an upper portion of a power section of a shock apparatus in accordance with one or more embodiments of the present disclosure.

FIG. 5 shows an enlarged cross-sectional view of a lower portion of a power section coupled to an upper portion of a second piston section of a shock apparatus in accordance with one or more embodiments of the present disclosure.

FIG. 6 shows an enlarged cross-sectional view of a lower portion of a second piston section coupled to an upper portion of a lower housing section of a shock apparatus in accordance with one or more embodiments of the present disclosure.

FIG. 7 shows an enlarged cross-sectional view of a lower housing section of a shock apparatus in accordance with one or more embodiments of the present disclosure.

FIG. 8 shows an enlarged cross-sectional view of a coupling between a lower portion of a second piston section and an upper portion of a lower housing section of a shock apparatus in accordance with one or more embodiments of the present disclosure.

FIG. 9 shows an enlarged cross-sectional view of a coupling between a lower portion of a second piston section and an upper portion of a lower housing section of a shock apparatus in accordance with one or more embodiments of the present disclosure.

### DETAILED DESCRIPTION

Specific embodiments of the present disclosure will now be described in detail with reference to the accompanying figures. In the following description of some embodiments of the present disclosure, numerous specific details are set forth in order to provide a more thorough understanding of such embodiments. However, it will be apparent to out of ordinary skill in the art in view of the disclosure herein that the embodiments disclosed herein may be practiced without these specific details. In other instances, well-known features have not been described in detail to avoid unnecessarily complicating the description.

Embodiments disclosed herein relate to apparatuses, tools, assemblies, systems, and methods for dampening or reducing vibration e.g. axial, lateral, rotational, or a combination thereof) within a downhole tool or assembly. An embodiment in accordance with the present disclosure may include a power section, with the power section including a stator and a rotor with an annulus formed therebetween. A first piston chamber may be fluidly coupled (i.e., having fluid communication therebetween) with one end portion of the annulus, and a second piston chamber may be fluidly coupled with another end portion of the annulus. The first piston chamber and/or the second piston chamber may then be used to reduce or dampen energy from fluid transmitted within the annulus of the power section. As the power section may be coupled to a drill bit or other rotary tool, which may in turn be coupled to an end portion of the tool, the first piston chamber and/or the second piston chamber may be used to reduce vibration, such as rotational vibration, received into the power section through the drill bit or other rotary tool. Further, the power section may have a throughbore formed therethrough, such as a throughbore formed within the rotor, in which the annulus formed between the stator and the rotor is fluidly sealed from the throughbore.

To provide an understanding of an example environment in which embodiments of the present disclosure may be used. FIG. 1 illustrates a drilling system 100 for drilling an earth formation. The drilling system 100 may include a drilling rig 110 that may lift, lower, inject, turn, or otherwise manipulate a drilling tool assembly 112 extending downwardly into a wellbore 114. The drilling tool assembly 112 may include a drill string 116 with a bottomhole assembly 118 having a drill bit 120 at a distal end thereof.

The drill string 116 ma include several joints of drill pipe 116-1 connected end-to-end through one or more tool joints 116-2. In other embodiments, the drill string 116 may include coiled tubing, or other continuous materials. Regardless of the type of components used to form the drill pipe 116, the drill string 116 may transmit drilling fluid (e.g., through a central bore) from the drill rig 110 to the drill bit 120. In some embodiments, (e.g., where joints of drill pipe 116-1 are used), the drill string 116 may also be used to transmit rotational torque to the drill bit 120. In other embodiments, a downhole motor (e.g., mud motor) may be used transmit torque to the drill bit 120. When the drill string 116 uses coiled tubing, for instance, drilling fluid may pass to a mud motor which converts the axial fluid flow to rotational energy for rotating the drill bit 120. The drill string 116 may provide a hydraulic passage through which drilling fluid (e.g.; mud) is pumped. The drilling fluid may be discharged through selected-size orifices or jets in the drill bit 120, and used to cool the drill bit 120 and lift cuttings out of wellbore 114 and toward the surface.

During drilling, the drill bit 120, drill string 116, and bottomhole assembly 118 may experience axial, lateral, rotational, or other vibrations due to various downhole and/or surface forces. Due to the vibration, the drill string 116, bottomhole assembly 118, drill bit 120, or other components may bend, twist, bounce, or otherwise deviate off-course. Consequently, the wellbore may deviate from the desired course, become larger than desired, suffer from poor wellbore quality, or have other undesired features. Further, vibration may cause damage to one or more of the drill string components (116, 118, and 120) and any downhole components disposed therein or coupled thereto. As such, a shock absorption tool 122 may be coupled to the bottomhole assembly 112, drill string 116, drill bit 120, or other component and used to reduce vibration and negative consequences resulting from such vibrations.

Referring now to FIGS. 2-9, multiple cross-sectional views of an illustrative shock absorption tool or apparatus 200 are shown in accordance with one or more embodiments of the present disclosure. The shock absorption apparatus 200 may have a throughbore 201, and may include multiple sections, such as an upper housing section 210, a first piston section 220, a power section 240, a second piston section 250, a lower housing section 270, other sections, or a combination of the foregoing. One of ordinary skill in the art will appreciate in view of the disclosure herein that though the shock absorption apparatus 200 is shown having multiple sections coupled to each other, one or more of the sections may be integrally formed with each other.

With reference to the shock absorption apparatus 200, FIG. 2 shows a cross-sectional view of the entirety of the shock absorption apparatus 200, while FIGS. 3-9 show enlarged views of specific sections and portions of the shock absorption apparatus 200. Particularly, FIG. 3 shows an enlarged cross-sectional view of the upper housing section 210 coupled to an upper portion of the first piston section 220. FIG. 4 shows an enlarged cross-sectional view of a lower portion of the first piston section 200 coupled to an upper portion of the power section 240. FIG. 5 shows an enlarged cross-sectional view of a lower portion of the power section 240 coupled to an upper portion of the second piston section 250, and FIG. 6 shows an enlarged cross-sectional view of a lower portion of the second piston section 250 coupled to an upper portion of the lower housing section 270. FIG. 7 shows an enlarged cross-sectional view of the lower housing section 270, and FIGS. 8 and 9 show enlarged cross-sectional views of a coupling between the lower portion of the second piston section 250 and the upper portion of the lower housing section 270.

As shown in FIG. 2, a shock absorption apparatus 200 may include a throughbore 201 to allow fluid (e.g. drilling fluid or mud), to be pumped through the shock absorption apparatus 200 from an upper end portion 203 to a lower end portion 205. The throughbore 201 may extend from and through the upper housing section 210, through the first piston section 220, the power section 240, and the second piston section 250, and into and through the lower housing section 270.

The upper housing section 210 may be configured to couple to or engage with a drill string, tool, or assembly (e.g., a bottomhole assembly). For example, the upper end portion 203 may include a box member 204 for threadingly engaging a pin member (not shown) of a drill string, downhole tool, bottomhole assembly component, or other component. Similarly, the lower housing section 270 may be configured to engage with a tool, assembly, drill bit, or other component. For example, the lower end portion 205 may include a box member 206 for threadingly engaging a pin member (not shown) of a drill bit (see drill bit 120 of FIG. 1) and facilitating coupling thereto.

As shown in FIGS. 2, 4, and 5, the shock absorption apparatus 200 may include a power section 240, with the power section 240 optionally including a stator 241 and a rotor 243. The rotor 243 may be positioned inside the stator 241, and an annulus 245 may be defined between the rotor 243 and the stator 241. The rotor 243 may be arranged and designed to rotate with respect to the stator 241. This relative rotation between the rotor 243 and the stator 241 may be used to pump, transmit, force, or otherwise flow fluid through the annulus 245 formed between the rotor 243 and the stator 241.

In one or more embodiments, the stator 241 may be a helical stator, and the rotor 243 may be an eccentric helical rotor. In a particular embodiment, a power section 240 may fit within the diameter restrictions of the shock absorption apparatus 200. In at least some embodiments, the power section 240 may be or include a progressive cavity pump, also referred to as a positive displacement pump and/or a Moineau pump. Those skilled in the art will appreciate in view of the present disclosure, however, that any type of power section may be used in one or more embodiments of the present disclosure. For instance, a positive displacement pump or motor may be used.

If the rotor 243 rotates in one direction with respect to the stator 241, fluid may be pumped in one direction through the annulus 245 of the power section 240 (e.g., by pumping fluid toward the first piston section 220). If the rotor 243 rotates in an opposing direction with respect to the stator 241, fluid may be pumped in the other direction through the annulus 245 of the power section 240 (e.g., by pumping fluid toward the second piston section 250). Thus, the stator 241 and the rotor 243 of the power section 240 may be selectively rotated to pump fluid through the annulus 245 of the power section 240. Further, the throughbore 201, which extends through the rotor 243 of the power section 240, may be fluidly sealed from the annulus 245 formed between the rotor 243 and the stator 241 to restrict if not prevent fluid that passes through the throughbore 201 of the shock absorption apparatus 200 from mixing or combining with the fluid that passes through the annulus 245 of the power section 240. Accordingly, the fluid within the annulus 245 and which is used in transmitting forces to the piston sections, as described in more detail herein, may be considered a closed system.

As shown in FIGS. 2-4, the shock absorption apparatus 200 may include a first piston section 220, which may include a first piston 221 and a first piston chamber 223. The first piston 221 may have a length that is less than a length of the first piston chamber 223, and may be positioned at an intermediate location within the first piston chamber 223 in a manner that separates the first piston chamber 223 into a first side 225 (shown in FIG. 3) and a second side 227 (shown in FIG. 4). In some embodiments, the first piston 221 may be sealed within the first piston chamber 223 such that fluid in the first side 225 of the first piston chamber 223 will not mix with fluid in the second side 227 of the first piston chamber 223.

According to some embodiments, a first dampening member 229 may be disposed within the second side 227 of the first piston chamber 223. The first dampening member 229 may include one or more springs or other biasing members. For instance, the first dampening member 229 may include a plurality of Belleville springs, one or more elastomeric members or materials, other dampening members known to a person of ordinary skill in the art, or any combination of the foregoing, and which may be used to dampen forces and energy exerted upon the first piston 221 in the first piston chamber 223. For example, a dampening member may include one or more coil springs, one or more wave springs, one or more flat wire compression springs, one or more compressed air or gas chambers, or any combination of the above, to dampen energy applied thereto without departing from the scope of the present disclosure.

The first piston section 220 may include a first shaft 235 extending through the first piston section 220 and which may be coupled to the rotor 243. In some embodiments the first shaft 235 may be flexible and/or oriented to extend eccentrically through the shock absorption apparatus 200. As seen in FIGS. 3 and 4, for instance, the first shaft 235 may extend axially through the shock absorption apparatus 200 at an angle offset from a longitudinal axis of the shock absorption apparatus 200.

The first shaft 235 may extend the throughbore 201 through at least a portion of the shock apparatus (e.g., from the first piston section 220 to the rotor 243 of the power section 240. Further, with respect to FIGS. 3 and 4, the first side 225 of the first piston chamber 223 may include an inlet 231 or multiple inlets 231), and the second side 227 of the first piston chamber 223 may include a port 233 (or multiple ports 233). The first side 225 of the first piston chamber 223 may be fluidly coupled to the annulus 245 of the power section 240. Such fluid coupling may occur via a passage 237 and the inlet 231. As shown in FIG. 4, for instance, the passage 237 may be in fluid communication with the annulus 245, and may extend axially along the exterior of the first shaft 235. The passage 237 may also be in fluid communication with the inlet 231. The passage 237 may thus define a chamber or annular region (or eccentric annular region) between the first shaft 235 and the first piston chamber 223 (i.e., extending radially outwardly from the first shaft 235). The inlet 231 may fluidly couple the passage 237 to the first side 225 of the first piston chamber 223, while the second side 227 of the first piston chamber 223 may be fluidly coupled to the exterior of the shock absorption apparatus 200 through the port 233, such as fluidly coupled through the port 233 to an annulus formed between the shock absorption apparatus 200 and a wall of a wellbore.

Fluid may be pumped or otherwise moved from the annulus 245 of the power section 240 into and out of the first side 225 of the first piston chamber 223 by way of the inlet 231, which movement of the fluid may cause the first piston 221 to slide or otherwise move within the first piston chamber 223. Movement of the first piston 221 responsive to flow into and out of the first side 225 may cause fluid, to flow out of and into, respectively, the second side 227 of the first piston chamber 223 by way of the port 233. Energy resulting from the fluid flow into the first side 225 of the first piston chamber 223 may be dampened by the first dampening member 229 disposed within the second side 227 of the first piston chamber 223.

Similar to the first piston section 220, and as shown in FIGS. 2, 5, and 6, the shock absorption apparatus 200 may include a second piston section 250, having a second piston 251 and a second piston chamber 253. The second piston 251 sized to be positioned within the second piston chamber 253 in a manner that defines a first side 255 and a second side 257 of the second piston chamber 253. The second piston 251 may be sealed within the second piston chamber 253 such that fluid in the first side 255 of the second piston chamber 253 will not mix with fluid in the second side 257 of the second piston chamber 253.

A second dampening member 259 may be disposed within the second side 257 of the second piston chamber 253. The second dampening member 259 may comprise the same materials as the first dampening member 229 and include one or more springs or biasing members, such as a plurality of Belleville springs, one or more elastomeric members or materials, other dampening members, or any combination of the foregoing. The second dampening member may be used to dampen forces and energy exerted upon the second piston 251 in the second piston chamber 253. In some embodiments, the second dampening member 259 may include one or more coil springs, one or more wave springs, one or more flat wire compression springs, one or more compressed air or gas chambers, or any combination of the foregoing, to dampen energy applied thereto without departing from the scope of the present disclosure. In the same or other embodiments, the second dampening member 259 may comprise different materials as compared to the first dampening member 229.

The second piston section 250 may include a second shaft 265, such as a flexible shaft, extending through the second piston section 250. The second shaft 265 may extend the throughbore 201 through a portion of the shock absorption apparatus 200, and may extend from the rotor 243 of the power section 240 through the second piston section 250. Further, the first side 255 of the second piston chamber 253 may include an inlet 261, and the second side 257 of the second piston chamber 253 may include a port 263. The first side 255 of the second piston chamber 253 may be fluidly coupled to the annulus 245 of the power section 240 via a passage 267 and the inlet 261. The passage 267 may be fluidly coupled to the annulus 245 and may be formed between the second shaft 265 and the second piston chamber 253 (i.e., extending, radially outwardly from the second shaft 265, and along the axial length thereof). The inlet 261 may fluidly couple the passage 267 to the first side 255 of the second piston chamber 253. The second side 257 of the second piston chamber 253 may be fluidly coupled to the exterior of the shock absorption apparatus 200 through the port 263, such as fluidly coupled through the port 263 to an annulus formed between the shock absorption apparatus 200 and a wall of a wellbore. In some embodiments, the passage 267 may have an eccentric annular shape, such as where the second shaft 265 extends at an angle that is non-parallel and/or co-axial relative to a longitudinal axis of the shock absorption apparatus 200.

Fluid may be pumped or otherwise moved from the annulus 245 of the power section 240 into and out of the first side 255 of the second piston chamber 253 by way of the inlet 261, which may cause the second piston 251 to slide or otherwise move within the second piston chamber 253. Movement of the second piston 251, responsive to flow into and out of the first side 255, may cause fluid to flow out of and into, respectively, the second side 257 of the second piston chamber 253 by way of the port 263. Energy resulting from the fluid flow into the first side 255 of the second piston chamber 253 may be dampened by the second dampening, member 259 disposed within the second side 257 of the second piston chamber 253.

Those skilled in the art will appreciate in view of the disclosure herein that although the dampening members 229, 259 may be disposed in the second sides 227, 257, respectively, of the piston chambers 233, 253 and inlets 231, 261 may be provided on the first sides 225, 255 of the piston chambers 233, respectively, embodiments of the present disclosure are not so limited. For example, the first dampening member 229 may be disposed within the first side 225 of the first piston chamber 223 as compared to the second side 227 of the first piston chamber 223, and then the inlet 231 may be provided to the second side 227 of the first piston chamber 223. In the same or other embodiments, the second dampening member 259 and the inlet 261 may be similarly rearranged. The present disclosure therefore contemplates other arrangements and embodiments for a shock absorption apparatus 200 besides those expressly shown in FIGS. 2-9.

Referring now to FIG. 7, the lower housing section 270 of the shock absorption apparatus 200 is shown and includes a lower end portion 201 to which a drill bit (not shown) or other downhole tool may be coupled. The lower housing section 270 may include a housing 271 and a third shall 273 disposed within the housing 271. The third shaft 273 may be able to rotate with respect to the housing 271, in which embodiment the drill bit may be coupled to the third shaft 273 to also rotate with respect to the housing 271. According to at least some embodiments, the third shaft 273 may be coupled to the second shaft 265 (e.g., through a turnbuckle connection or other coupling). The second shaft 265 may be coupled to the rotor 243 of the power section 240; therefore, the third shaft 273 and a drill bit or other tool or assembly coupled to the third shaft 273 may also be coupled to the rotor 243 of the power section 240.

The lower housing section 270 may include a bearing pack 275, which may be used in some embodiments to facilitate rotation of the third shaft 273 with respect to the housing 271. The bearing pack 275 may be disposed about the third shaft 273 in an annular region between the third shaft 273 and the housing 271. One skilled in the art should appreciate in view of the present disclosure that the hearing pack 275 may include one or more bearings, bushings, or other elements that facilitate rotation. For example, the bearing pack 275 may include one or more balls, rollers, bearings, sleeves, bushings, pads, or other devices, in which the bearings or bushings may be axially disposed along a length of the third shaft 273.

Referring now to FIGS. 8 and 9, enlarged cross-sectional views of an illustrative turnbuckle connection 280 are shown in accordance with one or more embodiments of the present disclosure. The turnbuckle connection 280 may be used to couple the third shaft 273 of the lower housing section 270 to the second shaft 265 of the second piston section 250. As shown, particularly in FIG. 9, the end portions of the third shaft 273 and the second shaft 265 may include complimentary notches, serrations, or other features to couple the third shaft 273 and the second shaft 265 to each other. Further, the turnbuckle connection 280 may include an inner sleeve 281 and an outer sleeve 283 to facilitate the coupling between the third shall 273 and the second shaft 265. For example, the inner sleeve 281 may be used to threadingly engage the outer surface of the end portion of the second shaft 265, and the outer sleeve 283 may be used to threadingly engage the outer surface of the end portion of the third shaft 273. The inner sleeve 281 and the outer sleeve 283 may then threadingly engage each other, such as by having a surface on the outer diameter of the inner sleeve 281 threadingly engage a surface on the inner surface of the outer sleeve 283. Of course, in other embodiments, the sleeve engaged with, or otherwise coupled to, the second shaft 265 may be the outer sleeve, while the inner sleeve ma be engaged with, or otherwise coupled, the third shaft 273.

The inner sleeve 281 may have opposing threads such that the turnbuckle connection 280 or other coupling may be used to move the second shaft 265 and the third shaft 273 toward each other. For example, an upper end portion of the inner sleeve 281 may have a left hand thread and a lower end portion of the inner sleeve 281 may have a right hand thread. The opposing threads may then move the second shaft 265 and the third shaft 273 toward and away from each other as the turnbuckle connection 280 is made-up and broken out. The turnbuckle connection 280 may be arranged such that the threaded area of the second shall 265 may have as large of a cross-section as possible considering the space constraints within the wellbore and shock absorption apparatus 200. Thus, the inside diameter of the threaded area of the lower end portion of the second piston section 250 may be sufficiently large to permit disposition of the inner sleeve 281. The inner sleeve 281 may be coupled to the second shaft 265 after the inner sleeve 281 has been inserted into the second piston section 250. As particularly shown in FIG. 9, the turnbuckle connection 280 may include complementary notches, serrations, or other features on the end portions of the second shall 265 and the third shaft 273 for additional torque capacity. The shear area through the notches may provide more torque capacity than friction forces between loaded flat shoulders. The complementary notches of the turnbuckle connection 280 may also be arranged such that the third shaft 273 may be torqued to the second shaft 265 by torqueing the large outside diameter of the third shaft 273 and/or the inner sleeve 281. The outer sleeve 283 may then be moved toward the lower end portion of the third shaft 273 by the threads between the inner sleeve 281 and the outer sleeve 283, thus loading against the hearing pack 275 on the third shaft 273 so that the bearing pack 275 may be compressed, such as against the bearings within the bearing pack 275 and against, a shoulder at the lower end portion of the third shaft 273, restricting and potentially preventing the bearing pack 275 from rotating on the third shaft 273.

As shown particularly in FIG. 8, the turnbuckle connection 280 may also include a seal sleeve 285 included therewith in some embodiments. The seal sleeve 285 may be disposed between and/or along an inner surface of an end portion of the second shaft 265 and the inner surface of an end portion of the third shaft 273. The seal sleeve 285 may be used to facilitate fluidly coupling the throughbore 201 through and between the second shaft 265 and the third shaft 273. In other words, the seal sleeve 285 may seal the throughbore 201 at the junction between the second shaft 265 and the third shaft 273.

Further, as shown in FIGS. 2 and 7-9, the shock absorption apparatus 200 ma include a fluid port 277, which in some embodiments may be positioned in the lower housing section 270. The fluid port 277 may be fluidly coupled with, and therefore in fluid communication with, the passage 267 formed about the second shaft 265, the inlet 261 of the first side 255 of the second piston chamber 253, the annulus 245 formed within the power section 240, the passage 237 formed about the first shaft 235, the inlet 231 of the first side 225 of the first piston chamber 223, or some combination of the foregoing. Fluid (e.g., hydraulic fluid or some other similar lubricating, fluid) may be introduced through the fluid port 277, such as when pre-charging the shock absorption apparatus 200 and introducing fluid into the passage 267. Those skilled in the art will appreciate in view of the present disclosure that although the fluid port 277 is shown as included within the lower housing section 270 of the shock absorption apparatus 200, the fluid port 277 may be included anywhere along the length of the shock absorption apparatus 200. Further, the fluid port 277 may be sealed and/or a one-way valve may be used to provide fluid into the shock absorption apparatus 200, but restricting or even preventing fluid from leaking out of the shock absorption apparatus 200.

The shock absorption apparatus 200 may be pre-charged with fluid by, for instance, introducing fluid into the power section 240 of the shock absorption apparatus 200, such as by fluid port 277, to prime and ready the shock absorption apparatus 200. One feature of such process may include introducing fluid into the passage 267 formed about the second shaft 265, the inlet 261 of the first side 255 of the second piston chamber 251, the annulus 245 formed within the power section 240, the passage 237 formed about the first shaft 235, the inlet 231 of the first side 225 of the first piston chamber 223, or a combination of one or more of the foregoing. As the throughbore 201 of the shock absorption apparatus 200 is fluidly sealed from each of the passage 267, the first side 255 of the second piston chamber 253, the annulus 245, the passage 237, and the first side 225 of the first piston chamber 223, fluid introduced through the fluid port 277 may not enter, mix, or combine with fluid in the throughbore 201.

When in use, the shock absorption apparatus 200 may have a drill bit or other downhole tool coupled to the lower end portion 205 and arranged to rotate and drill an earthen formation. For example, fluid (e.g., drilling fluid or mud) may be pumped through the throughbore 201 of the shock absorption apparatus 200 to operate a mud motor disposed above or below the shock absorption apparatus 200. The mud motor then rotates the drill bit. If no mud motor is used, torque may be applied to the shock absorption apparatus 200 through a drill string (e.g., by imparting torque to the drill string from an oil rig disposed at the surface). When the drill bit is coupled to the third shaft 273, rotation imparted to the drill bit may also rotate the third shaft 273 and/or other components coupled to the third shaft 273 (e.g., the second shaft 265, the rotor 243, the first shaft 235, or a combination thereof). Further, torque imparted to the drill bit may also be imparted the third shaft 273 and/or other components coupled to the third shaft 273.

Vibration, and in particular rotational vibration, experienced by the drill bit when drilling through the earthen formation may also be imparted to the third shaft 273, the second shaft 265, the rotor 243, the first shaft 235, or some combination of the foregoing. Whenever increased/decreased torque is received from the rotating drill bit, the rotor 243 may also be rotating with respect to the stator 241 in the power section 240. The rotation and increased torqueing of the rotor 243 with respect to the stator 241 may then pump and force fluid to flow through the annulus 245 formed between the rotor 243 and the stator 241 and to one of the first piston chamber 223 or the second piston chamber 253. Conversely, when torque received from the drill hit is decreasing, the rotor 243 may rotate in the opposite direction with respect to the stator 241.

If fluid is pumped from the annulus 245 to the first piston chamber 223, fluid may be drawn from the first side 255 of the second piston chamber 253, flow through the annulus 245, and into the first side 225 of the first piston chamber 253. This may then allow the first piston 221 to move and apply pressure and force to the first dampening member 229, and allow the second piston 251 to relieve pressure and force from the second dampening member 259. As pressure and force are then applied to the first dampening member 229, the first dampening member 229 may be used to reduce and dampen energy from the fluid that was exerted from the drill bit. For example, as vibrations may be exerted from the drill bit and into the fluid within the annulus 245 of the power section 240, this vibrational energy may be reduced and dampened by the first dampening member 229 that is absorbing the energy from the fluid that is in fluid communication with the annulus 245 of the power section 240. As will be clearly understood by those skilled in the art in view of the disclosure herein, the converse will happen if fluid is pumped from the annulus 245 to the second piston chamber 253.

A shock absorption apparatus 200 in accordance with the present disclosure may include one or more flow restrictors, such as disposed within one or more of the passage 267, the first side 255 of the second piston chamber 253, the annulus 245, the passage 237, or the first side 225 of the first piston chamber 223, to selectively restrict flow within the shock absorption apparatus 200 as desired. An example of a flow restrictor in accordance with one or more embodiments of the present disclosure may include one or more orifices, orifice plates, impediments, contractions, or other restrictors included with and/or disposed within the shock absorption apparatus 200, such as disposed within the passage 267, the first piston chamber 223, or the second piston chamber 253, to limit or restrict fluid flow within the shock absorption apparatus 200. As such, a flow restrictor may be used to dampen flow and rotational movement within the shock apparatus such that the shock apparatus dampens vibrations at a desired rate.

An apparatus in accordance with one or more embodiments of the present disclosure may be used in multiple areas, including but not limited to the oil and gas industry. For example, a shock apparatus in accordance with one or more embodiments of the present disclosure may be used to reduce and dampen vibration received from a drill bit when drilling a wellbore or forming a lateral borehole, a milling bit when milling a casing, an underreamer when widening a wellbore, or the like. Further, a shock apparatus in accordance with one or more embodiments of the present disclosure may transmit fluid internally therein; therefore, the shock apparatus may not have to adjust in length, such as by increasing or decreasing, in length to accommodate the vibration dampening.

A shock apparatus in accordance with the present disclosure may also be customized to the desires, limitations, and restrictions of the environment in which the shock apparatus is to be used. For example, a spring rate or coefficient of the shock apparatus may be changed to adjust the dampening or to replace one or more of the dampening members within the shock apparatus. The shock apparatus may also dampen torque shock loads by having a reduced torsional spring rate, as compared to other bottomhole assembly members. Also, the spring-mass system of the shock apparatus may change the torsional natural frequency of a bottomhole assembly such that drill bit bounce may be reduced by the ability of the shock apparatus to absorb shock and vibration. Further, the shock apparatus may be adjusted and/or customized to match the bottomhole assembly characteristics for mitigating, effects related to self-excitation of a drill string. Such unmitigated effects may lead to dynamic instability and cause one or more of slipping, sticking, or bouncing of a drill bit within the wellbore.

While embodiments herein have been described with primary reference to downhole tools and drilling rigs, such embodiments are provided solely to illustrate one environment in which aspects of the present disclosure may be used. In other embodiments, rotary shock tools, systems, assemblies, methods, and other components discussed herein, or which would be appreciated in view of the disclosure herein, may be used in other applications, including in automotive, aquatic, aerospace, hydroelectric, or other industries.

In the description and in the claims, the terms “including” and “comprising” are used in an open-ended fashion, and thus should be interpreted to mean “including, but not limited to . . . .” Further, the terms “axial” and “axially” generally mean along or parallel to a central or longitudinal axis, while the terms “radial” and “radially” generally mean perpendicular to a central longitudinal axis.

In the description herein, various relational terms are provided to facilitate an understanding of various aspects of some embodiments of the present disclosure in relation to the provided drawings. Relational terms such as “bottom,” “below,” “top,” “above,” “back,” “front,” “left”, “right”, “rear”, “forward”, “up”, “down”, “horizontal”, “vertical”, “clockwise”, “counterclockwise,” “upper”, “lower”, and the like, may be used to describe various components, including their operation and/or illustrated position relative to one or more other components. Relational terms do not indicate a particular orientation for each embodiment within the scope of the description or claims. For example, a component of a bottomhole assembly that is “below” another component may be more downhole while within a vertical wellbore, but may have a different orientation during assembly, when removed from the wellbore, or in a deviated borehole. Accordingly, relational descriptions are intended solely for convenience in facilitating reference to various components, but such relational aspects may be reversed, flipped, rotated, moved in space, placed in a diagonal orientation or position, placed horizontally or vertically, or similarly modified. Relational terms may also be used to differentiate between similar components; however, descriptions may also refer to certain components or elements using designations such as “first,” “second,” “third,” and the like. Such language is also provided merely for differentiation purposes, and is not intended limit a component to a singular designation. As such, a component referenced in the specification as the “first” component may for some but not all embodiments be the same component referenced in the claims as a “first” component.

Furthermore, to the extent the description or claims refer to “an additional” or “other” element, feature, aspect, component, or the like, it does not preclude there being a single element, or more than one, of the additional element. Where the claims or description refer to “a” or “an” element, such reference is not be construed that there is just one of that element, but is instead to be inclusive of other components and understood as “one or more” of the element. It is to be understood that where the specification states that a component, feature, structure, function, or characteristic “may,” “might,” “can,” or “could” be included, that particular component, feature, structure, or characteristic is provided in some embodiments, but is optional for other embodiments of the present disclosure. The terms “couple,” “coupled,” “connect,” “connection,” “connected,” “in connection with,” and “connecting” refer to “in direct connection with,” “integral with,” or “in connection with via one or more intermediate elements or members.”

Certain embodiments and features may have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges may appear in one or more claims below. Any numerical value is “about” or “approximately” the indicated value, and take into account experimental error and variations that would be expected by a person having ordinary skill in the art.

In the claims, means-plus-function clauses are intended to cover the structures described herein as performing the recited function, including both structural equivalents and equivalent structures. Thus, although a nail and a screw may not be structural equivalents in that a nail employs a cylindrical surface to couple wooden parts together, whereas a screw employs a helical surface, in the environment of fastening wooden pans, a nail and a screw may be equivalent structures. It is the express intention of the applicant riot to invoke 35 U.S.C. §112, paragraph 6 for any limitations of any of the claims herein, except for those in which the claim expressly uses the words ‘means for’ together with an associated function.

What is claimed is:

1. A shock absorption apparatus, comprising:
a stator;
a rotor interior relative to the stator, the stator and rotor defining an annulus between the stator and rotor;
a first piston section defining a first piston chamber having a first piston therein, the first piston chamber being fluidly coupled to a first end portion of the annulus; and
a second piston section defining a second piston chamber having a second piston therein, the second piston chamber being fluidly coupled to a second end portion of the annulus.

2. The apparatus of claim 1, the annulus between the stator and the rotor being fluidly sealed from a throughbore within the rotor.

3. The apparatus of claim 1, the first piston separating a first side of the first piston chamber from a second side of the first piston chamber, the first side of the first piston chamber being fluidly coupled to the annulus and the second side of the first piston chamber having a first dampening member therein.

4. The apparatus of claim 3, the first dampening member comprising a spring.

5. The apparatus of claim 3, the second side of the first piston chamber comprising a port fluidly coupling the second side of the first piston chamber to an exterior of the shock absorption apparatus.

6. The apparatus of claim 1, the second piston separating a first side of the second piston chamber from a second side of the second piston chamber, the first side of the second piston chamber being fluidly coupled to the annulus and the second side of the second piston chamber having a second dampening member therein.

7. The apparatus of claim 1, further comprising:
a first flexible shaft extending through the first piston chamber, the first flexible shaft being coupled to an upper end portion of the rotor, and a throughbore of the first flexible shaft being fluidly aligned with a throughbore of the rotor.

8. The apparatus of claim 7, further comprising:
a second flexible shaft extending through the second piston chamber, the second flexible shaft being, coupled to a lower end portion of the rotor, and a throughbore of the second flexible shaft being fluidly aligned with the throughbore of the rotor.

9. The apparatus of claim 1, further comprising:
a drill bit coupled to an end portion of the second piston section, the drill hit further being coupled to the rotor.

10. The apparatus of claim 9, further comprising:
a turnbuckle connection coupling the drill bit to the rotor.

11. The apparatus of claim 9, further comprising:
a housing coupled to the stator;
a shaft within the housing and coupled to the drill bit at the end portion of the second piston section; and
a bearing pack between the shaft and the housing and facilitating rotation of the shaft with respect to the housing.

12. A method comprising:
rotating a bit coupled to a rotor, the rotor being interior to a stator, wherein rotating the bit rotates the rotor with respect to the stator;
flowing fluid through an annulus formed between the rotor and the stator to a first piston chamber in response to the rotation of the rotor with respect to the stator; and
dampening energy from the fluid with a first dampening member within the first piston chamber.

13. The method of claim 12, wherein a first piston is within the first piston chamber and separates the first piston chamber into a first side and a second side, and wherein dampening energy from the fluid with a first dampening member comprises:
compressing a first spring in the second side of the first piston chamber.

14. The method of claim 13, further comprising:
receiving, fluid in the second side of the first piston chamber through a port formed within the second side of the first piston chamber; and
releasing the first spring from compression.

15. The method of claim 12, further comprising:
flowing fluid through the annulus from the first piston chamber to a second piston chamber; and
dampening energy from the fluid with a second dampening member within the second piston chamber.

16. The method of claim 12, the stator and the rotor being, included within a power section of shock absorption apparatus that includes the first piston chamber and the first dampening member, the power section being pre-charged with fluid.

17. The method of claim 12, the annulus between the stator and the rotor being fluidly sealed from a throughbore of the rotor.

18. The method of claim 12, wherein rotating the bit coupled to the rotor includes transmitting torque from the bit to the rotor to rotate the rotor with respect to the stator.

19. A tool comprising:
a helical stator;
an eccentric helical rotor interior to the helical stator, an annulus being defined between the helical stator and the eccentric helical rotor;
a first piston chamber having a first piston therein, the first piston separating the first piston chamber into a first side and a second side, the first side of the first piston chamber being in fluid communication with the annulus and the second side of the first piston chamber having a first dampening member therein; and
a second piston chamber having a second piston therein, the second piston separating the second piston chamber into a first side and a second side, the first side of the second piston chamber being in fluid communication with the annulus and the second side of the second piston chamber having a second dampening member therein.

20. The tool of claim 19, the eccentric helical rotor having a throughbore extending therethrough, the throughbore being fluidly sealed from the annulus.
